(19) United States
(12) Patent Application Publication
(10) Pub. No.: US 2026/0102983 A1
(43) Pub. Date: Apr. 16, 2026

(54) VULCANIZING DEVICE FOR MANUFACTURING HIGH-SULFUR ACTIVATED RUBBER TIRE

(71) Applicant: SHANDONG LINGLONG TIRE CO., LTD., Yantai (CN)

(72) Inventors: FENG WANG, Yantai (CN); CHENJING WU, Yantai (CN); YONG MA, Yantai (CN); YUSHI LI, Yantai (CN); JING ZHANG, Yantai (CN); HAIGUANG HAN, Yantai (CN); HUI WANG, Yantai (CN); LU LIU, Yantai (CH)

(73) Assignee: SHANDONG LINGLONG TIRE CO., LTD., Yantai (CN)

(21) Appl. No.: 19/346,535

(22) Filed: Sep. 30, 2025

Related U.S. Application Data
(63) Continuation of application No. PCT/CN2024/124848, filed on Oct. 15, 2024.

(30) Foreign Application Priority Data
Oct. 10, 2024 (CN) 2024114050654

(51) Int. Cl. B29D 30/06

(52) U.S. Cl. CPC B29D 30/0662; B29D 2030/067; B29D 2030/0677

(57) ABSTRACT

A vulcanizing device for manufacturing high-sulfur activated rubber tires is provided, and relates to the technical field of tire processing and specifically includes a base. A top end of the base is connected with a movable seat through a first hydraulic telescopic rod, a top of the movable seat is fixedly connected with a lower die adapted to a rubber tire, a middle of the movable seat is provided with a fixing hole, and a sealing connection structure is arranged below the fixing hole; a groove is arranged outside the fixing hole, and an inner cavity of the groove is movably connected with a limiting ring adapted to a green tire, and the limiting ring is connected with the movable seat through second hydraulic telescopic rods.

### CROSS-REFERENCE TO RELATED APPLICATIONS

This application is a continuation of PCT/CN2024/124848, filed on Oct. 15, 2024 and claims priority of Chinese Patent Application No. 202411405065.4, filed on Oct. 10, 2024, the contents of which are hereby incorporated by reference.

### TECHNICAL FIELD

The disclosure relates to the technical field of tire processing, and in particular to a vulcanizing device for manufacturing high-sulfur activated rubber tires.

### BACKGROUND

High-sulfur activated rubber tires need to be vulcanized in the manufacturing process, and a vulcanizing machine is needed in this process. At present, the vulcanizing machine usually vulcanizes the tire by pressing the mold. The specific operation is as follows: to put the green tire between the sealed vulcanizing bladder and the vulcanizing mold, saturated steam is introduced into the vulcanizing bladder to heat the vulcanizing bladder and the vulcanizing mold, so as to provide the heat needed for vulcanizing to the green tire, and then high-pressure nitrogen is introduced into the vulcanizing bladder to provide the pressure needed for vulcanizing, so that the vulcanizing bladder expands and presses the green tire, and the green tire is shaped and vulcanized with the vulcanizing machine to improve the strength of the tire. When the scheme is used, the volume of the vulcanizing bladder needs to be expanded to be the same as that of the inner cavity of the green tire, and gas is continuously introduced into the vulcanizing bladder to realize the heating or extrusion operation of the green tire. When the vulcanized rubber is taken out, the gas in the vulcanizing rubber bladder needs to be completely exhausted, which undoubtedly increases the vulcanization time of the tire and reduces the vulcanization speed of the tire. Moreover, when the tire is taken and placed, workers need to reach under the mold with their hands or tools, which reduces the safety and working efficiency during use. Based on this, the disclosure puts forward a vulcanizing device for manufacturing high-sulfur activated rubber tires.

### SUMMARY

The disclosure provides a vulcanizing device for manufacturing high-sulfur activated rubber tires, which solves the problems in the above background technology that when the tire is vulcanized, the volume of a vulcanizing bladder needs to be expanded to be the same as that of the inner cavity of a green tire, which increases the vulcanization time of the tire and reduces the vulcanization speed of the tire, and when the tire is taken and placed, workers need to reach under the mold with hands or tools, which reduces the safety and working efficiency during use.

The disclosure provides the following technical scheme: a vulcanizing device for manufacturing high-sulfur activated rubber tires includes a base, a top end of the base is connected with a movable seat through a first hydraulic telescopic rod, a top of the movable seat is fixedly connected with a lower die adapted to a rubber tire, a middle of the movable seat is provided with a fixing hole, and a sealing connection structure is arranged below the fixing hole; a groove is arranged outside the fixing hole, and an inner cavity of the groove is movably connected with a limiting ring adapted to a green tire, and the limiting ring is connected with the movable seat through second hydraulic telescopic rods; a top of the base is connected with a sealing cover through third hydraulic telescopic rods, a bottom end of an inner cavity of the sealing cover is provided with an upper die adapted to the lower die, and a middle of the sealing cover is connected with an airbag structure through a fourth hydraulic telescopic rod;
where the sealing connection structure includes a fifth hydraulic telescopic rod fixedly connected with the moving base, a movable plate connected with the fifth hydraulic telescopic rod, a blocking rod connected with one end at a top of the movable plate through a spring, and an air inlet pipe and an exhaust pipe connected with an other end at the top of the movable plate;
the airbag structure includes an insertion rod adapted to the fixing hole, a bottom end of the insertion rod is uniformly and fixedly connected with sixth hydraulic telescopic rods, and an other end of each of the sixth hydraulic telescopic rods is connected with a vulcanizing bladder through a shaping block, and the vulcanizing bladder is fixedly connected with connecting pipes adapted to the air inlet pipe and the exhaust pipe, a top end of the insertion rod is uniformly and fixedly connected with seventh hydraulic telescopic rods, and a bottom of each of the seventh hydraulic telescopic rods is fixedly connected with one of eighth hydraulic telescopic rods, an other end of each of the eighth hydraulic telescopic rods is fixedly connected with an another shaping block.

Preferably, the sixth hydraulic telescopic rods and the eighth hydraulic telescopic rods are alternately arranged, and shaping blocks in the airbag structure are capable of forming an annular structure adapted to an inner diameter of the green tire.

Preferably, the insertion rod is fixedly connected with a tail end of an output shaft of the fourth hydraulic telescopic rod, and the connecting pipes are telescopic pipes.

Preferably, the end of the top of the movable plate is fixedly connected with a limiting rod, an outer ring of the limiting rod is movably sleeved with the blocking rod, a middle of the limiting rod is provided with a spring groove, and a bottom of an inner cavity of the spring groove is fixedly connected with a spring, and an other end of the spring is connected with a top of an inner cavity of the blocking rod.

Preferably, each of ends of both the air inlet pipe and the exhaust pipe is provided with an electric ball valve.

Preferably, a bottom of the movable seat is at a same height as the top of the base.

Preferably, a bottom of the blocking rod is fixedly connected with a pressure sensor, and a height value of the blocking rod is same as a depth value of the fixing hole.

Preferably, an outer surface of the sealing cover is wrapped with a thermal insulation pad.

Compared with the prior art, the disclosure has the following beneficial effects.

Firstly, according to the vulcanizing device for manufacturing high-sulfur activated rubber tires, through the arrangement of the airbag structure, during the vulcanization process of rubber tires, the shaping blocks may occupy a part of the space in the green tire, so that the amount of gas required when the vulcanizing bladder presses against the green tire is reduced, so that the gas may quickly contact with the green tire and press the green tire, and then the vulcanization speed of the green tire may be improved.

Secondly, according to the vulcanizing device for manufacturing high-sulfur activated rubber tires, through the arrangement of the movable seat, the lower die and the upper die are in a staggered state, so that when the tire is taken and placed, workers may not need to reach under the mold with hands or tools, and the safety of the vulcanizing device is improved And when the high-sulfur activated rubber tire is taken and placed, the airbag structure is separated from the lower die, so that the moving height of the high-sulfur activated rubber tire becomes lower, and the taking and placing efficiency of the high-sulfur activated rubber tire is further improved.

### BRIEF DESCRIPTION OF THE DRAWINGS

FIG. 1 is a schematic diagram of the mold clamping of a structure according to an embodiment of the disclosure;

FIG. 2 is a schematic diagram of the mold opening of the structure according to an embodiment of the disclosure;

FIG. 3 is a schematic diagram of the airbag structure of the structure according to an embodiment of the disclosure;

FIG. 4 is an explosion schematic diagram of FIG. 3 of the structure according to an embodiment of the disclosure;

FIG. 5 is a schematic bottom diagram of FIG. 3 of the structure according to an embodiment of the disclosure;

FIG. 6 is a schematic diagram of the movable seat in a top view of the structure according to an embodiment of the disclosure;

FIG. 7 is a schematic bottom diagram of the movable seat of the structure according to an embodiment of the disclosure;

FIG. 8 is an explosion schematic diagram of the movable seat of the structure according to an embodiment of the disclosure; and

FIG. 9 is a schematic diagram of the bottom of the blocking rod of the structure according to an embodiment of the disclosure.

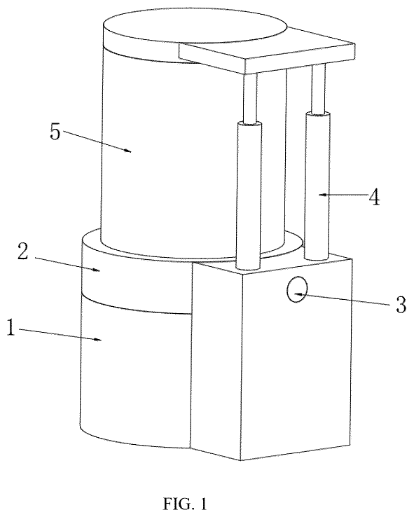

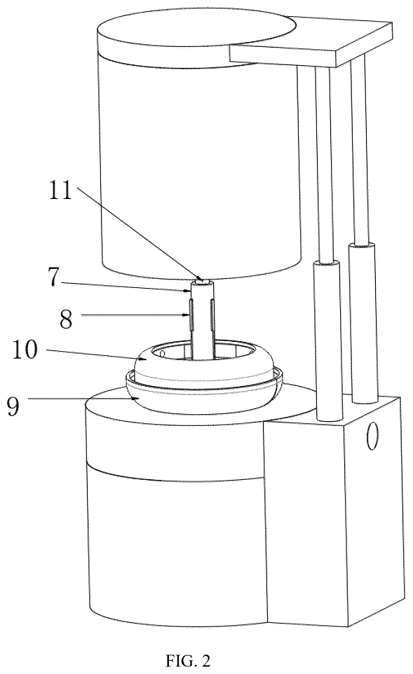

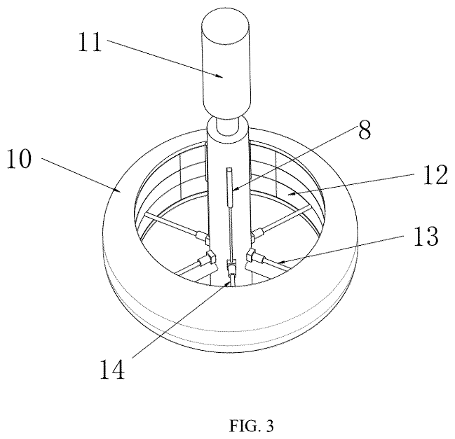

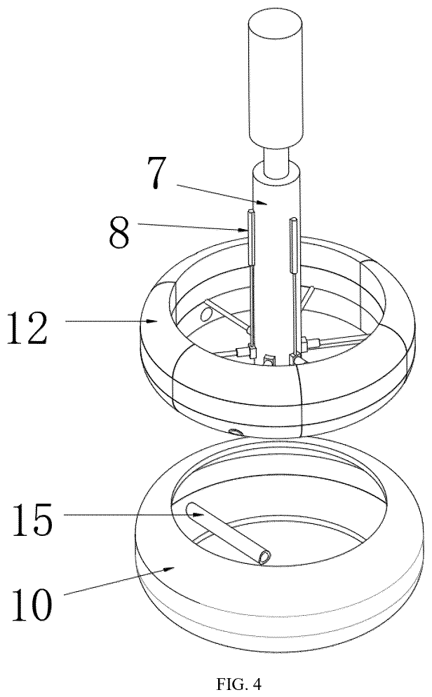

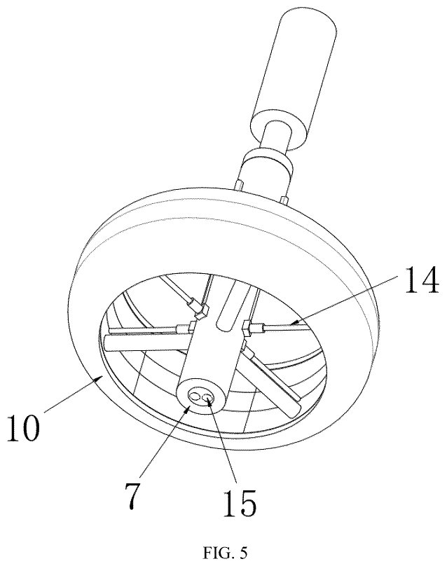

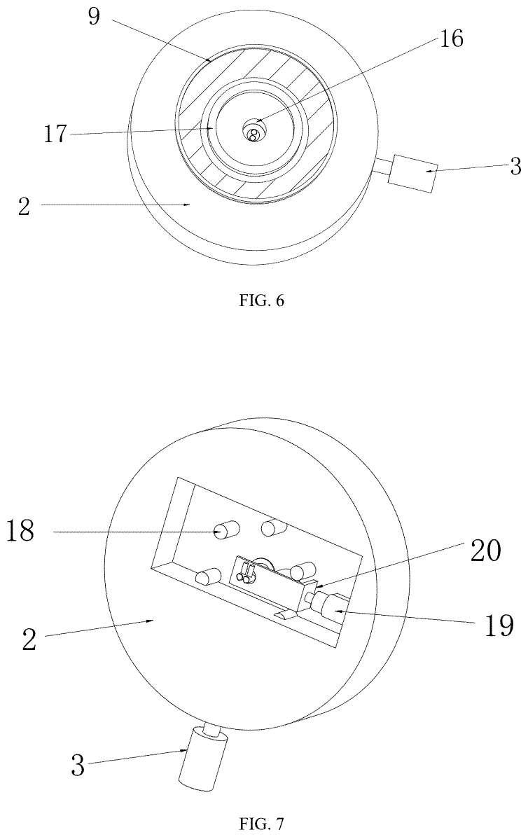

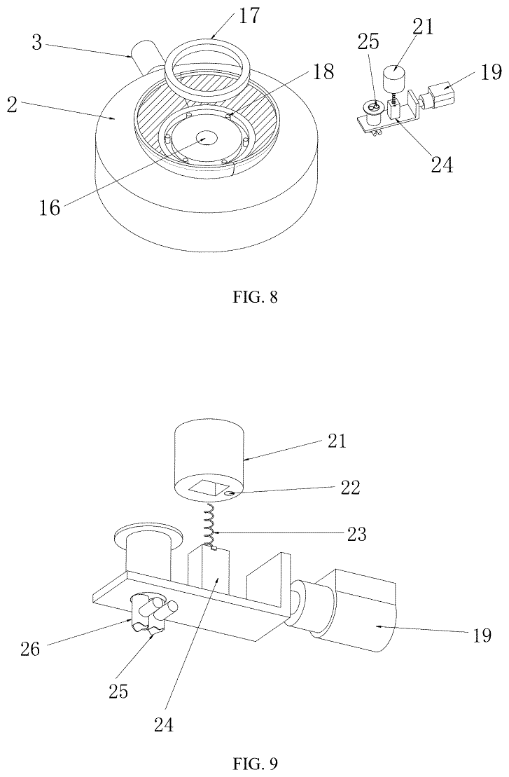

List of reference characters: 1 base; 2 movable seat; 3 first hydraulic telescopic rod; 4 third hydraulic telescopic rod; 5 sealing cover; 7 insertion rod; 8 seventh hydraulic telescopic rod; 9 lower die; 10 vulcanizing bladder; 11 fourth hydraulic telescopic rod; 12 shaping block; 13 sixth hydraulic telescopic rod; 14 eighth hydraulic telescopic rod; 15 connecting pipe; 16 fixing hole; 17 limiting ring; 18 second hydraulic telescopic rod; 19 fifth hydraulic telescopic rod; 20 movable plate; 21 blocking rod; 22 pressure sensor; 23 spring; 24 limiting rod; 25 exhaust pipe; and 26 air inlet pipe.

### DETAILED DESCRIPTION OF THE EMBODIMENTS

In the following, the technical scheme in the embodiments of the disclosure will be described clearly and completely with reference to the attached drawings in the embodiments of the disclosure. Obviously, the described embodiment is only a part of the embodiments of the disclosure, but not all of the embodiments. Based on the embodiments in the disclosure, all other embodiments obtained by ordinary skilled in the field without creative efforts belong to the scope of protection of the disclosure.

A vulcanizing device for manufacturing high-sulfur activated rubber tires is provided, and includes a base 1, a top end of the base 1 is connected with a movable seat 2 through a first hydraulic telescopic rod 3. The top of the base 1 is connected with the sealing cover 5 through the third hydraulic telescopic rods 4. When the first hydraulic telescopic rod 3 is completely contracted, the movable seat 2 is located directly below the sealing cover 5, and the bottom of the movable seat 2 is at the same height as the top of the base. When the first hydraulic telescopic rod 3 is completely contracted, the base 1 may support the movable seat 2, which is convenient for vulcanization of the rubber tire. When the first hydraulic telescopic rod 3 is extended, the movable seat 2 may be separated with the sealing cover 5, so that when the tire is taken and placed, the worker may not need to reach under the mold with hands or tools, and the safety of the vulcanizing device is improved.

A top of the movable seat 2 is fixedly connected with a lower die 9 adapted to a rubber tire, a middle of the movable seat 2 is provided with a fixing hole 16, and a sealing connection structure is arranged below the fixing hole 16. A groove is arranged outside the fixing hole 16, and an inner cavity of the groove is movably connected with a limiting ring 17 adapted to a green tire, and the limiting ring 17 is connected with the movable seat 2 through second hydraulic telescopic rods 18. The depth value of the groove is not less than the height value of the limiting ring 17, and the limiting ring 17 may be completely hidden in the inner cavity of the groove under the action of the second hydraulic telescopic rods 18, so as to avoid the limiting ring 17 from limiting the tire and facilitate the vulcanization of the rubber tire. The depth value of the groove may be set as required, and there is no restriction here.

The sealing connection structure includes a fifth hydraulic telescopic rod 19 fixedly connected with the moving base 2, a movable plate 20 connected with the fifth hydraulic telescopic rod 19. The expansion and contraction of the fifth hydraulic telescopic rod 19 may change the position of the movable plate 20 fixedly connected with it. The end of the top of the movable plate 20 is fixedly connected with a limiting rod 24, an outer ring of the limiting rod 24 is movably sleeved with the blocking rod 21, a middle of the limiting rod 24 is provided with a spring groove, and a bottom of an inner cavity of the spring groove is fixedly connected with a spring 23, and an other end of the spring 23 is connected with a top of an inner cavity of the blocking rod 21. Through the arrangement of the limiting rod 24, the limiting rod 24 may limit the blocking rod 21 and limit the moving height of the blocking rod 21. By setting the spring 23, the distance between the blocking rod 21 and the limiting rod 24 may be changed, and when the restriction on the blocking rod 21 is released, the resilience of the spring 23 may push the blocking rod 21 to move.

A height value of the blocking rod 21 is the same as a depth value of the fixing hole 16. The fixing hole 16 may be blocked by the blocking rod 21 to prevent impurities from falling into the inner cavity of the fixing hole 16.

A bottom of the blocking rod 21 is fixedly connected with a pressure sensor 22. By setting the pressure sensor 22, the position of the blocking rod 21 may be detected, and the moving accuracy of the blocking rod 21 may be ensured.

The other end of the movable plate 20 is provided with an air inlet pipe 26 and an exhaust pipe 25, and one end of each of both the air inlet pipe 26 and the exhaust pipe 25 is provided with an electric ball valve, by which the air inlet speed and the air exhaust speed may be controlled.

A bottom end of an inner cavity of the sealing cover 5 is provided with an upper die adapted to the lower die 9, and a middle of the sealing cover 5 is connected with an airbag structure through a fourth hydraulic telescopic rod 11. The expansion and contraction of the fourth hydraulic telescopic rod 11 may change the position of the airbag structure fixedly connected with it.

The airbag structure includes an insertion rod 7 adapted to the fixing hole 16, and the insertion rod 7 is fixedly connected with the tail end of the output shaft of the fourth hydraulic telescopic rod 11. When the vulcanizing device is used, the bottom of the insertion rod 7 is inserted into the inner cavity of the fixing hole 16, and the bottom of the insertion rod 7 is at the same height as the top of the blocking rod 21. At this time, the insertion depth of the insertion rod 7 may be monitored by using the pressure sensor 22 to ensure the insertion accuracy of the insertion rod 7.

The bottom end of the insertion rod 7 is uniformly and fixedly connected with sixth hydraulic telescopic rods 13, and the other end of each of the sixth hydraulic telescopic rods 13 is connected with a vulcanizing bladder 10 through a shaping block 12. Through the arrangement of the sixth hydraulic telescopic rods 13, the expansion and contraction of the sixth hydraulic telescopic rods 13 may change the position of the shaping block 12 fixedly connected with each of the sixth hydraulic telescopic rods, and when the position of the shaping blocks 12 change, the vulcanizing bladder 10 may be pulled to change the volume of the vulcanizing bladder 10. The vulcanizing bladder 10 is fixedly connected with connecting pipes 15 adapted to the air inlet pipe 26 and the exhaust pipe 25. The connecting pipes 15 are telescopic pipes, and the material of the connecting pipes 15 may be corrugated pipes with high temperature and high pressure resistance. There are at least two connecting pipes 15, and when the air inlet pipe 26 and the exhaust pipe 25 contact with the bottom of the insertion rod 7, the top of the air inlet pipe 26 closely adheres to the bottom of one of the connecting pipes 15, and the top of the exhaust pipe 25 closely adheres to the bottom of the other one of the connecting pipes 15.

The top end of the insertion rod 7 is uniformly and fixedly connected with seventh hydraulic telescopic rods 8, the bottom of each of the seventh hydraulic telescopic rods 8 is fixedly connected with an eighth hydraulic telescopic rod 14, and the other end of the eighth hydraulic telescopic rod 14 is fixedly connected with another shaping block 12. The expansion and contraction of the seventh hydraulic telescopic rod 8 may change the position of the eighth hydraulic telescopic rod 14, and the expansion and contraction of the eighth hydraulic telescopic rod 14 may change the position of another shaping block 12. The above-mentioned sixth hydraulic telescopic rods 13 and eighth hydraulic telescopic rods 14 are alternately arranged, and the shaping blocks 12 are arc-shaped. All the shaping blocks 12 in the airbag structure may form an annular structure adapted to the inner diameter of the green tire. At this time, the annular structure supports the vulcanizing bladder 10 into an annular shape structure, and when the vulcanizing bladder 10 is inflated, the vulcanizing bladder 10 may expand uniformly.

From the above description of the airbag structure, it may be seen that the shaping block 12 may occupy a part of the space in the green tire during the vulcanization process of the rubber tire, thus reducing the amount of gas required when the vulcanizing bladder 10 presses the green tire, improving the contact speed between the gas and the tire, and further improving the vulcanization speed of the green tire.

The outer surface of the sealing cover 5 is wrapped with a thermal insulation pad, which may be made of pearl cotton. By setting the thermal insulation pad, the heat loss during tire vulcanization may be reduced and the energy consumption of the device may be reduced.

To sum up, when the vulcanizing device for manufacturing high-sulfur activated rubber tires is used, when the green tire of vulcanized activated rubber tire need to be placed, the movable seat 2 and the sealing cover 5 are in a separated state, and the second hydraulic telescopic rods 18 extend, and the second hydraulic telescopic rods 18 drive the limiting ring 17 to move into the inner cavity of the lower die 9, and the limiting ring 17 may limit the green tire. After the green tire is placed in the inner cavity of the lower die 9, the first hydraulic telescopic rod 3 contracts. The second hydraulic telescopic rods 18 contract until the movable seat 2 moves directly below the sealing cover 5, and the second hydraulic telescopic rods 18 drive the limiting ring 17 to move downwards until the limiting ring 17 is hidden in the cavity of the groove, and the third hydraulic telescopic rods 4 contract, and the third hydraulic telescopic rods 4 drive the sealing cover 5 to move downwards. When the sealing cover 5 is completely attached to the bottom of the base 1, the lower die 9 and the upper die are closed to form mold closing, and during the contraction of the third hydraulic telescopic rods 4, the fourth hydraulic telescopic rod 11 extends and drives the airbag structure to move downwards until the bottom of the insertion rod 7 is at the same height as the top of the blocking rod 21. The fourth hydraulic telescopic rod 11 contracts, and the contraction height of the fourth hydraulic telescopic rod 11 is the same as that of the third hydraulic telescopic rod 4, so that the position of the airbag structure remains fixed. During the insertion of the insertion rod 7, the blocking rod 21 is squeezed by the insertion rod 7 and moves downwards. When the insertion rod 7 is completely inserted into the fixing hole 16, the blocking rod 21 is separated from the fixing hole 16, and the pressure is monitored by the pressure sensor 22. The fifth hydraulic telescopic rod 19 drives the movable plate 20 to move, and the movable plate 20 drives the blocking rod 21 to move, so that the blocking rod 21 is staggered from the fixing hole 16 until the air inlet pipe 26 and the exhaust pipe 25 move below the fixing hole 16, at which time the top of the air inlet pipe 26 is closely attached to the bottom of the connecting pipe 15, and the top of the exhaust pipe 25 is closely attached to the bottom of the other connecting pipe 15. During the contraction of the fourth hydraulic telescopic rod 11, the sixth hydraulic telescopic rods 13 drive the shaping block 12 to move, and the shaping block 12 moves into the inner cavity of the green tire, and the seventh hydraulic telescopic rod 8 drives the eighth hydraulic telescopic rod 14 to move down until the position of the eighth hydraulic telescopic rod 14 is at the same height as that of the fourth hydraulic telescopic rod 11, and the eighth hydraulic telescopic rod 14 extends and drives the other shaping block 12 to move. Until the other shaping blocks 12 and the shaping blocks 12 form an annular structure, the cavity of the green tire is partially occupied by the annular structure, and the amount of gas required for vulcanizing bladder 10 to squeeze the green tire is reduced, so that the gas may quickly contact with the green tire and squeeze the green tire, thereby improving the vulcanization speed of the green tire. The gas steam and high-pressure nitrogen required in the tire vulcanization process enters the inner cavity of the vulcanizing bladder 10 through the air inlet pipe 26 and the connecting pipe 15 contacting with the air inlet pipe 26, thereby increasing the volume of the vulcanizing bladder 10, and the excess gas in the vulcanizing bladder 10 is exhausted through another connecting pipe contacting with the exhaust pipe 25 and the exhaust pipe 25.

During demoulding, the vulcanizing bladder 10 is deflated, and after the other shaping block 12 is separated from the vulcanizing bladder 10, the eighth hydraulic telescopic rod 14 and the seventh hydraulic telescopic rod 8 drive the other shaping block 12 to reset, the fourth hydraulic telescopic rod 11 drives the shaping block 12 to reset, and the airbag structure is separated from the high-sulfur activated rubber tire, the third hydraulic telescopic rods 4 drive the sealing cover 5 to move up, and the sealing cover 5 drives the upper die and the airbag structure to move up. When the airbag structure moves above the tire, the first hydraulic telescopic rod 3 extends, and the first hydraulic telescopic rod 3 drives the movable seat 2 to move until the movable seat 2 is staggered with the sealing cover 5, which is convenient for taking and placing the tire.

The standard parts used in the disclosure may be purchased from the market, and the special-shaped parts may be customized according to the description in the specification and the attached drawings. The specific connection mode of each part adopts conventional means such as bolts, rivets, welding, etc. which are mature in the prior art, and the machinery, parts and device adopt conventional models in the prior art, which will not be described in detail here. What is not described in detail in this specification belongs to the prior art which is well known to professionals in this field. Although embodiments of the disclosure have been shown and described, it will be understood by those skilled in the art that various changes, modifications, substitutions and variations may be made to these embodiments without departing from the principles and spirit of the disclosure, the scope of which is defined by the appended claims and their equivalents.

What is claimed is:

1. A vulcanizing device for manufacturing high-sulfur activated rubber tires, comprising a base, wherein: a top end of the base is connected with a movable seat through a first hydraulic telescopic rod, a top of the movable seat is fixedly connected with a lower die adapted to a rubber tire, a middle of the movable seat is provided with a fixing hole, and a sealing connection structure is arranged below the fixing hole; a groove is arranged outside the fixing hole, and an inner cavity of the groove is movably connected with a limiting ring adapted to a green tire, and the limiting ring is connected with the movable seat through second hydraulic telescopic rods; a top of the base is connected with a sealing cover through third hydraulic telescopic rods, a bottom end of an inner cavity of the sealing cover is provided with an upper die adapted to the lower die, and a middle of the sealing cover is connected with an airbag structure through a fourth hydraulic telescopic rod;
wherein the sealing connection structure comprises a fifth hydraulic telescopic rod fixedly connected with the moving base, a movable plate connected with the fifth hydraulic telescopic rod, a blocking rod connected with one end at a top of the movable plate through a spring, and an air inlet pipe and an exhaust pipe connected with an other end at the top of the movable plate;
the airbag structure comprises an insertion rod adapted to the fixing hole, a bottom end of the insertion rod is uniformly and fixedly connected with sixth hydraulic telescopic rods, and an other end of each of the sixth hydraulic telescopic rods is connected with a vulcanizing bladder through a shaping block, and the vulcanizing bladder is fixedly connected with connecting pipes adapted to the air inlet pipe and the exhaust pipe, a top end of the insertion rod is uniformly and fixedly connected with seventh hydraulic telescopic rods, and a bottom of each of the seventh hydraulic telescopic rods is fixedly connected with one of eighth hydraulic telescopic rods, an other end of each of the eighth hydraulic telescopic rods is fixedly connected with an another shaping block.

2. The vulcanizing device for manufacturing high-sulfur activated rubber tires according to claim 1, wherein the sixth hydraulic telescopic rods and the eighth hydraulic telescopic rods are alternately arranged, and shaping blocks in the airbag structure are capable of forming an annular structure adapted to an inner diameter of the green tire.

3. The vulcanizing device for manufacturing high-sulfur activated rubber tires according to claim 1, wherein the insertion rod is fixedly connected with a tail end of an output shaft of the fourth hydraulic telescopic rod, and the connecting pipes are telescopic pipes.

4. The vulcanizing device for manufacturing high-sulfur activated rubber tires according to claim 1, wherein the end of the top of the movable plate is fixedly connected with a limiting rod, an outer ring of the limiting rod is movably sleeved with the blocking rod, a middle of the limiting rod is provided with a spring groove, and a bottom of an inner cavity of the spring groove is fixedly connected with a spring, and an other end of the spring is connected with a top of an inner cavity of the blocking rod.

5. The vulcanizing device for manufacturing high-sulfur activated rubber tires according to claim 1, wherein each of ends of both the air inlet pipe and the exhaust pipe is provided with an electric ball valve.

6. The vulcanizing device for manufacturing high-sulfur activated rubber tires according to claim 1, wherein a bottom of the movable seat is at a same height as the top of the base.

7. The vulcanizing device for manufacturing high-sulfur activated rubber tires according to claim 1, wherein a bottom of the blocking rod is fixedly connected with a pressure sensor, and a height value of the blocking rod is same as a depth value of the fixing hole.

8. The vulcanizing device for manufacturing high-sulfur activated rubber tires according to claim 1, wherein an outer surface of the sealing cover is wrapped with a thermal insulation pad.
